(19) United States
(12) Patent Application Publication
(10) Pub. No.: US 2012/0152692 A1
(43) Pub. Date: Jun. 21, 2012

(54) SENSING APPARATUS AND FINANCIAL DEVICE

(75) Inventor: TAE HOON KIM, Seoul (KR)

(73) Assignee: LG N-SYS, INC., Seoul (KR)

(21) Appl. No.: 13/325,864

(22) Filed: Dec. 14, 2011

(30) Foreign Application Priority Data
Dec. 16, 2010 (KR) 10-2010-0128882

(51) Int. Cl. B65G 13/02; H01J 40/14

(52) U.S. Cl. 198/339.1; 250/216

(57) ABSTRACT

Provided is a financial device, which comprises a transferring device, a light emitting sensor, and a light receiving sensor. The transferring device comprises a first guider and a second guider, which are spaced apart from each other to form a transfer path of a medium, and a frame on which the first and second guiders are installed. The light emitting sensor and the light receiving sensor sense the medium transferred along the transfer path of the medium. The light emitting sensor and the light receiving sensor do not overlap the transfer path of the medium in a direction vertical from the transfer path of the medium.

### CROSS-REFERENCE TO RELATED APPLICATIONS

This application claims the benefit under 35 U.S.C. 119 of Korean Patent Application No. 10-2010-0128882, filed Dec. 16, 2010, which is hereby incorporated by reference in its entirety.

### BACKGROUND

The present disclosure relates to a sensing apparatus and a financial device.

Financial devices automatically process a transaction a customer desires.

Financial devices may deposit/withdraw a medium such as a paper money and a check, or automatically transfer the medium. Such a financial device includes a sensor for sensing the presence of a transferred medium, and a control part connected to the sensor through a wire. The wire transmits an electrical signal from the sensor to the control part.

The sensor may be disposed on a guider for guiding the transferring of a medium. Thus, the wire connected to the sensor vertically overlaps a medium transfer path (region) at the guider. In this case, static electricity generated when a medium is transferred may affect the wire, thereby causing a signal transmission error of the sensor, or a signal recognition error of the control part.

### BRIEF SUMMARY

Embodiments provide a sensing apparatus and a financial device.

In one embodiment, a financial device comprises: a transferring device comprising a first guider and a second guider, which are spaced apart from each other to form a transfer path of a medium, and a frame on which the first and second guiders are installed; and a light emitting sensor and a light receiving sensor, which sense the medium transferred along the transfer path of the medium, wherein the light emitting sensor and the light receiving sensor do not overlap the transfer path of the medium in a direction vertical from the transfer path of the medium.

In another embodiment, a financial device comprises: a transferring device comprising a first guider and a second guider, which are spaced apart from each other to form a transfer path of a medium, and a frame on which the first and second guiders are installed; a light emitting sensor for emitting light to sense the medium transferred along the transfer path of the medium; a light receiving sensor receiving the light from the light emitting sensor; a control part electrically connected to the light emitting sensor and the light receiving sensor; a first wire connecting the light emitting sensor to the control part; and a second wire connecting the light receiving sensor to the control part, wherein the first wire and the second wire do not overlap the transfer path of the medium in a direction vertical from the transfer path of the medium.

In another embodiment, a sensing apparatus comprises: a light emitting sensor for emitting light; and a light receiving sensor sensing the light emitted from the light emitting sensor to generate an electrical signal, wherein the light emitting sensor and the light receiving sensor do not overlap a plane of a sensing region for sensing the presence of an object, in a direction vertical from the plane of the sensing region.

The details of one or more embodiments are set forth in the accompanying drawings and the description below. Other features will be apparent from the description and drawings, and from the claims.

### BRIEF DESCRIPTION OF THE DRAWINGS

FIG. 1 is a perspective view illustrating a financial device according to an embodiment.

FIGS. 2 and 3 are cross-sectional views illustrating a medium sensing apparatus of a financial device according to a first embodiment.

FIG. 4 is a cross-sectional view illustrating a medium sensing apparatus and a transferring device according to a second embodiment.

FIG. 5 is a cross-sectional view illustrating a medium sensing apparatus and a transferring device according to a third embodiment.

### DETAILED DESCRIPTION

Hereinafter, exemplary embodiments of the present disclosure will be described with reference to the accompanying drawings. Regarding the reference numerals assigned to the elements in the drawings, it should be noted that the same elements will be designated by the same reference numerals, wherever possible, even though they are shown in different drawings.

Also, in the description of embodiments, detailed description of well-known related structures or functions will be omitted when it is deemed that such description will cause ambiguous interpretation of the present disclosure.

Also, in the description of embodiments, terms such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, the former may be directly “connected,” “coupled,” and “joined” to the latter or “connected”, “coupled”, and “joined” to the latter via another component.

A financial device according to embodiments is a device that performs financial businesses, i.e., medium processing including processing such as deposit processing, giro receipt, or gift certificate exchange and/or processing such as withdrawal processing, giro dispensing, or gift certificate dispensing by receiving various media such as, e.g., paper moneys, bills, giros, coins, gift certificates, etc. For example, the financial device may comprise an automatic teller machine (ATM) such as a cash dispenser (CD) or a cash recycling device. However, the financial device is not limited to the above-described examples. For example, the financial device may be a device for automatically performing the financial businesses such as a financial information system (FIS).

Hereinafter, assuming that the financial device is the ATM, an embodiment will be described. However, this assumption is merely for convenience of description, and technical idea of the present disclosure is not limited to the ATM.

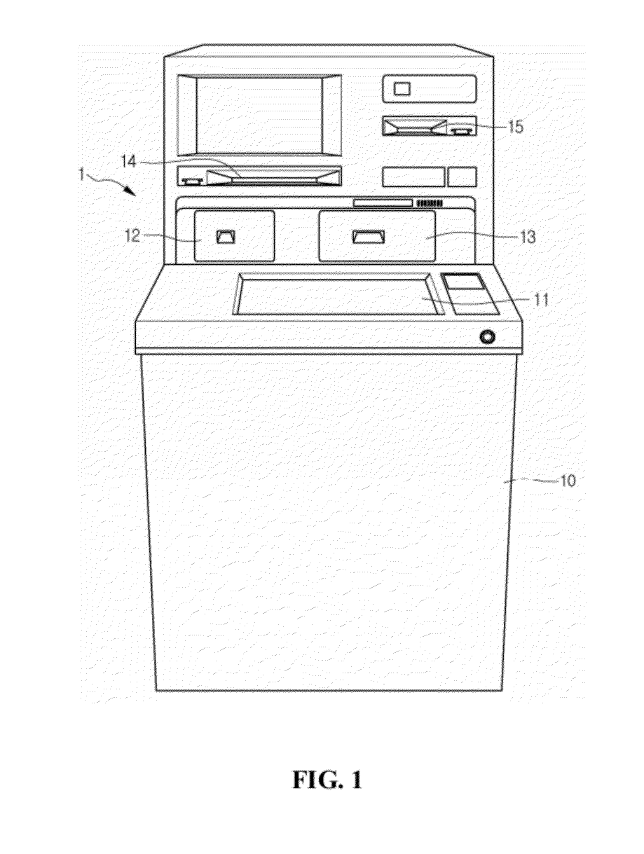

FIG. 1 is a perspective view illustrating a financial device according to an embodiment.

Referring to FIG. 1, a financial device 1 according to the current embodiment includes a main body 10 that accommodates a number of parts. The main body 10 may include an input part 11 for a user to perform a financial process, a check entrance 12 through which a check is input and output, a paper money entrance 13 through which a paper money is input and output, a bankbook entrance 14 through which a bankbook is input and output, and a card entrance 15 through which an integrated circuit (IC) card for a financial process is input and output. Since the financial device 1 may have a well-known structure, a description thereof will be omitted.

At least one of the check entrance 12, the paper money entrance 13, the bankbook entrance 14, and the card entrance 15 may be removed.

In the current embodiment, examples of a medium include securities such as a paper money, a check, and a token. A medium sensing apparatus to be described later may be disposed on a transfer path within the financial device 1 to sense a medium.

The medium sensing apparatus will now be described in detail.

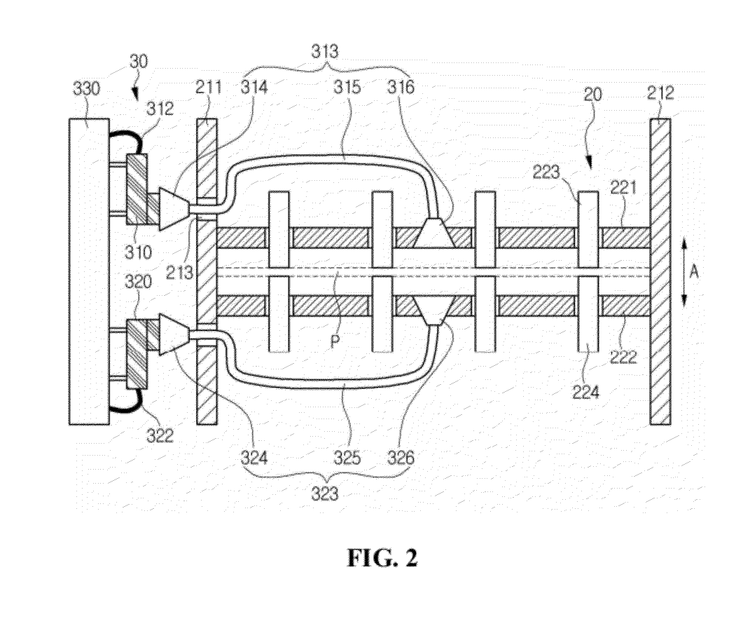

FIGS. 2 and 3 are cross-sectional views illustrating a medium sensing apparatus of a financial device according to a first embodiment.

Referring to FIGS. 2 and 3, a medium sensing apparatus according to the first embodiment includes: a transferring device 20 for transferring a medium; and a sensing apparatus 30 for sensing whether a medium is present in the transferring device 20, or passes through the transferring device 20.

The transferring device 20 includes a plurality of guiders 221 and 222 for guiding the transferring of the medium, and a plurality of rollers 223 and 224 for facilitating the transferring of the medium. The guiders 221 and 222 include an upper guider (also denoted by 221) and a lower guider (also denoted by 222) spaced apart from the upper guider 221. The medium passes between the upper guider 221 and the lower guider 222. The rollers 223 and 224 include one or more upper rollers (also denoted by 223) passing through the upper guider 221, and one or more lower rollers (also denoted by 224) passing through the lower guider 222. The medium may pass between the upper rollers 223 and the lower rollers 224.

Although an upper guider is vertically spaced apart from a lower guider in the current embodiment, guiders may be horizontally spaced apart from each other. Thus, two guiders forming a transfer path of a medium may be referred to as first and second guiders.

The upper guider 221 and the lower guider 222 are disposed between frames 211 and 212. Although not shown, the frames 211 and 212 may be fixed to specific positions of the main body 10. The frames 211 and 212 include a first frame (also denoted by 211) and a second frame (also denoted by 212). The frames 211 and 212, and the guiders 221 and 222 define the transfer path of the medium, or a medium transfer path P. The first frame 211 is connected to a side of the guiders 221 and 222, and the second frame 212 is connected to the other side of the guiders 221 and 222.

The sensing apparatus 30 includes: a light emitting sensor 310 for emitting light; a light receiving sensor 320 for receiving the light emitted from the light emitting sensor 310; a control part 330 connected to the light emitting sensor 310 and the light receiving sensor 320 through wires 312 and 322 for transmitting an electrical signal; and a plurality of light path parts 313 and 323 for transmitting the light from the light emitting sensor 310 to the light receiving sensor 320.

The light emitting sensor 310 and the light receiving sensor 320 may be laterally spaced apart from one of the frames 211 and 212 (or from a side of the guiders 221 and 222). In FIG. 2, the light emitting sensor 310 and the light receiving sensor 320 are disposed at a side of the first frame 211. That is, the light emitting sensor 310 and the light receiving sensor 320 may not overlap the transfer path of the medium in the vertical direction (in a direction A in FIG. 2). Also, the control part 330 may be laterally spaced apart from one of the frames 211 and 212. In FIG. 2, the control part 330 is disposed at a side of the first frame 211. The control part 330 may not vertically overlap the medium transfer path P.

Since the sensors 310 and 320 do not overlap the medium transfer path P, the sensors 310 and 320 are not disposed at the vertical upper side or vertical lower side of the medium transfer path P.

The first frame 211 includes holes 213 through which the light path parts 313 and 323 pass. Since the light path parts 313 and 323 pass through the holes 213, light substantially passes through the holes 213.

The light path parts 313 and 323 provide a light path through which light is emitted from the light emitting sensor 310 to the light receiving sensor 320. The light path parts 313 and 323 include a first path part (also denoted by 313) connected to the light emitting sensor 310, and a second path part (also denoted by 323) connected to the light receiving sensor 320. The first path part 313 is vertically spaced apart from the second path part 323. The medium may pass between an end of the first path part 313 and an end of the second path part 323. That is, the medium transfer path P is disposed between the first path part 313 and the second path part 323.

Since the light emitting sensor 310 and the light receiving sensor 320 are disposed at a side of one of the frames 211 and 212, at least one portion of the first path part 313 and the second path part 323 may vertically overlap the medium transfer path P, so that light emitted from the light emitting sensor 310 can pass through the medium transfer path P.

The first path part 313 includes a first light guider 314 connected to the light emitting sensor 310, a first optical cable 315 connected to the first light guider 314, and a second light guider 316 connected to the first optical cable 315. The first light guider 314 converges light emitted from the light emitting sensor 310, on the first optical cable 315. An inner cross-section of the first light guider 314 decreases from the light emitting sensor 310 to the first optical cable 315. The second light guider 316 spreads light emitted from the first optical cable 315. An inner cross-section of the second light guider 316 increases in a direction away from the first optical cable 315. For example, the second light guider 316 may be disposed in the upper guider 221. Light emitted from the second light guider 316 is directed to the lower guider 222.

The second path part 323 includes a third light guider 324 connected to the light receiving sensor 320, a second optical cable 325 connected to the third light guider 324, and a fourth light guider 326 connected to the second optical cable 325. The fourth light guider 326 converges light emitted from the second light guider 316, on the second optical cable 325. Light converged by the fourth light guider 326 passes through the second optical cable 325, and is spread by the third light guider 324, and is incident to the light receiving sensor 320. The fourth light guider 326 faces the second light guider 316, so that light emitted from the second light guider 316 can be efficiently incident to the fourth light guider 326.

For example, when light is incident to the light receiving sensor 320, a low signal (or a high signal) may be generated from the light receiving sensor 320. On the contrary, when light is not incident to the light receiving sensor 320, a high signal (or a low signal) may be generated from the light receiving sensor 320. When a low signal (or a high signal) is generated from the light receiving sensor 320, the control part 330 concludes that a medium does not pass through the transferring device 20. On the contrary, when a high signal (or a low signal) is generated from the light receiving sensor 320, the control part 330 concludes that a medium passes through the transferring device 20. For example, a high or low signal generated from the light receiving sensor 320 may be determined by comparing the amount of received light with a reference amount. When the amount of receive light is greater than a reference amount, it may be concluded that the light receiving sensor 320 senses light. In addition, damage to the optical cables 315 and 325 can be calculated based on the amount of light received by the light receiving sensor 320. For example, even though the amount of received light is greater than the reference amount, the amount of light received when the optical cables 315 and 325 are damaged may be smaller than the amount of light received when the optical cables 315 and 325 are not damaged.

Since the light emitting sensor 310, the light receiving sensor 320, and the control part 330 do not overlap the medium transfer path P, the wire 312 for electrically connecting the light emitting sensor 310 to the control part 330, and the wire 322 for electrically connecting the light receiving sensor 320 to the control part 330 may not overlap the medium transfer path P. Thus, static electricity generated while the medium passes through the transferring device 20 is inhibited from negatively affecting an electrical signal transmitted through the wires 312 and 322. Thus, the sensing apparatus 30 can accurately sense the presence of the medium.

In addition, since the wires 312 and 322 do not overlap the medium transfer path P, the wires 312 and 322 can be protected from damage while the transferring device 20 is assembled or repaired.

Since the optical cables 315 and 325 provide a path through which light propagates, even when static electricity is generated while a medium passes through the transferring device 20, the static electricity is inhibited from affecting light propagating within the optical cables 315 and 325.

Although the second path part 323 connected to the light receiving sensor 320 is disposed under the first path part 313 connected to the light emitting sensor 310, the first path part 313 may be disposed under the second path part 323.

In addition, although the sensors 310 and 320 do not overlap vertically the medium transfer path P, at least one of the sensors 310 and 320 may vertically overlap the medium transfer path P, and the wires 312 and 322 may not overlap vertically the medium transfer path P.

Although the first path part 313 is opposite to the second path part 323 with reference to the medium transfer path P, the first and second path parts 313 and 323 may be disposed at a side of the medium transfer path P. In this case, light, emitted from the light emitting sensor 310 and reflected by a medium, may be incident to the light receiving sensor 320.

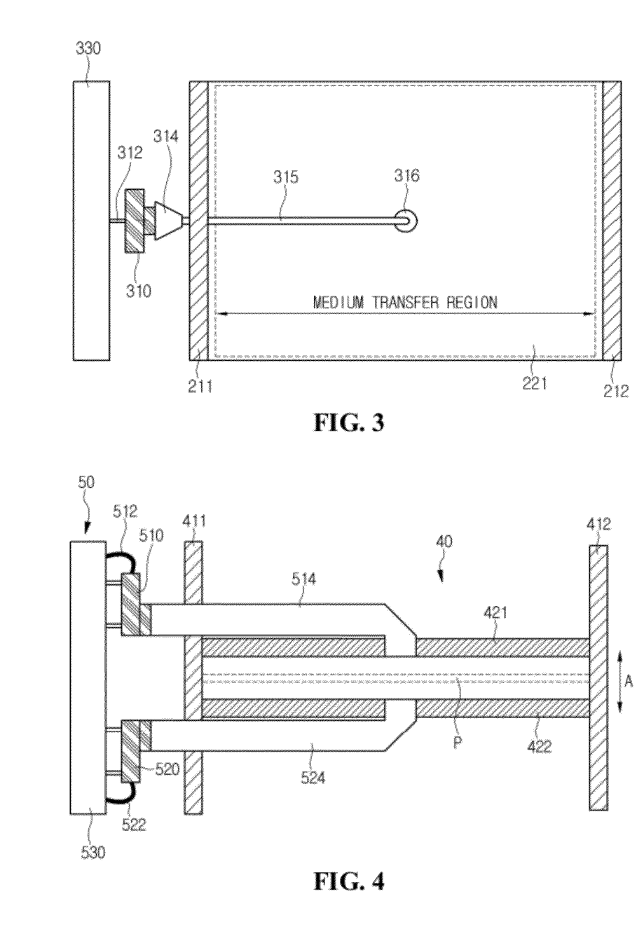

FIG. 4 is a cross-sectional view illustrating a medium sensing apparatus and a transferring device according to a second embodiment. A transferring roller is removed in FIG. 4.

Referring to FIG. 4, a financial device according to the current embodiment includes: a transferring device 40 for transferring a medium; and a sensing apparatus 50 for sensing whether a medium is present in the transferring device 40, or passes through the transferring device 40.

The transferring device 40 includes an upper guider 421 and a lower guider 422 to guide the transferring of the medium. The upper guider 421 and the lower guider 422 are disposed between a first frame 411 and a second frame 412. The frames 411 and 412, and the guiders 421 and 422 define a transfer path of a medium, or a medium transfer path P. Since the guiders 421 and 422, and the frames 411 and 412 may have the same structure as that of the first embodiment, a description thereof will be omitted.

The sensing apparatus 50 includes: a light emitting sensor 510 for emitting light; a light receiving sensor 520 for receiving the light emitted from the light emitting sensor 510; a control part 530 connected to the light emitting sensor 510 and the light receiving sensor 520 through wires 512 and 522 for transmitting an electrical signal; and a plurality of light path parts 514 and 524 for transmitting the light from the light emitting sensor 510 to the light receiving sensor 520.

The light emitting sensor 510 and the light receiving sensor 520 may be laterally spaced apart from one of the frames 411 and 412 (or from a side of the guiders 421 and 422. In FIG. 4, the light emitting sensor 510 and the light receiving sensor 520 are disposed at a side of the first frame 411. That is, the light emitting sensor 510 and the light receiving sensor 520 may not overlap the medium transfer path P vertically (in a direction A in FIG. 4). Also, the control part 530 may be laterally spaced apart from one of the frames 411 and 412. In FIG. 4, the control part 530 is disposed at a side of the first frame 411.

The light path parts 514 and 524 include a first path part (also denoted by 514) for providing a path through which light is emitted from the light emitting sensor 510, and a second path part (also denoted by 524) for guiding the light from the first path part 514 to the light receiving part 520.

The light path parts 514 and 524 may be prisms for refracting light. An end of the first path part 514 faces an end of the second path part 524, so that light emitted from the first path part 514 can be incident to the second path part 524. The first path part 514 is spaced apart from the second path part 524. The medium may pass between the end of the first path part 514 and the end of the second path part 524.

Since the light emitting sensor 510 and the light receiving sensor 520 are disposed at a side of one of the frames 411 and 412, the first path part 514 and the second path part 524 may vertically overlap the medium transfer path P, so that light emitted from the light emitting sensor 510 can pass through the medium transfer path P.

The shapes of the light path parts 514 and 524 are not limited thereto, and thus, may vary with the positions of the light emitting sensor 510 and the light receiving sensor 520. Each of the first and second path parts 514 and 524 may be provided in plurality.

Alternatively, one of the first and second path parts 514 and 524 may include a prism, and the other may include an optical cable.

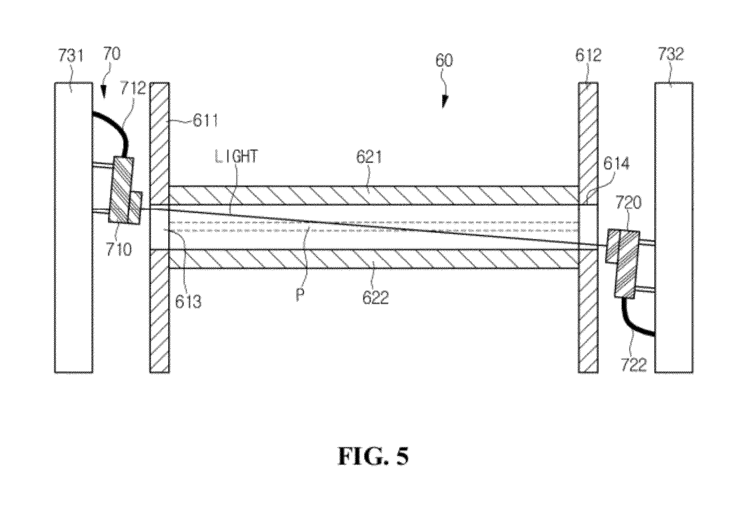

FIG. 5 is a cross-sectional view illustrating a medium sensing apparatus and a transferring device according to a third embodiment. A transferring roller is not shown in FIG. 5. Although not shown, the transferring roller may be spaced apart from the path of light emitted from a light emitting sensor.

Referring to FIG. 5, a financial device according to the current embodiment includes: a transferring device 60 for transferring a medium; and a sensing apparatus 70 for sensing whether a medium is present in the transferring device 60, or passes through the transferring device 60.

The transferring device 60 includes an upper guider 621 and a lower guider 622 to guide the transferring of the medium. The upper guider 621 is spaced apart from the lower guider 622.

The upper guider 621 and the lower guider 622 are disposed between a first frame 611 and a second frame 612. The frames 611 and 612, and the guiders 621 and 622 define a transfer path of a medium, or a medium transfer path P. Since the guiders 621 and 622, and the frames 611 and 612 may have the same structure as that of the first embodiment, a description thereof will be omitted.

The sensing apparatus 70 includes: a light emitting sensor 710 for emitting light; a light receiving sensor 720 for receiving the light emitted from the light emitting sensor 710; a first control part 731 connected to the light emitting sensor 710 through a wire 712 for transmitting an electrical signal; and a second control part 732 connected to the light receiving sensor 720 through a wire 722 for transmitting an electrical signal.

The light emitting sensor 710 may be disposed at a side of one of the frames 611 and 612 (or at a side of the guiders 621 and 622), and the light receiving sensor 720 may be disposed at a side of the other of the frames 611 and 612 (or at the other side of the guiders 621 and 622). In FIG. 5, the light emitting sensor 710 is disposed at a side of the first frame 611, and the light receiving sensor 720 is disposed at a side of the second frame 611.

Thus, the wires 711 and 722 connecting the sensors 710 and 720 to the control parts 731 and 732 do not overlap the medium transfer path P vertically. The medium passes between the light emitting sensor 710 and the light receiving sensor 720.

The first frame 611 includes a first hole 613 through which light emitted from the light emitting sensor 710 passes, and the second frame 612 includes a second hole 614 through which the light emitted from the light emitting sensor 710 passes. Thus, light emitted from the light emitting sensor 710 arrives at the light receiving sensor 720 through the first and second holes 613 and 614. The light emitting sensor 710 and the light receiving sensor 720 may be disposed at different heights to accurately sense a medium. In addition, the light emitting sensor 710 and the light receiving sensor 720 may be inclined from the guiders 621 and 622, so that light emitted from the light emitting sensor 710 can pass through the first hole 613, the medium transfer path P, and the second hole 614. Alternatively, the sensors 710 and 720 may be parallel to the guiders 621 and 622, and a light guider may guide light obliquely from the guiders 621 and 622.

According to the current embodiment, since there is no light path part, the structure of the financial device is simplified.

Although a light emitting sensor and a light receiving sensor as described above sense a medium, the light emitting sensor and the light receiving sensor may sense a certain object. Also in this case, the light emitting sensor and the light receiving sensor do not overlap vertically the horizontal plane of a sensing region (corresponding to the medium transfer path P) for sensing the presence of the object. Further, a light path part may be provided, which may vertically overlap the horizontal plane of the sensing region.

Even though all the elements of the embodiments are coupled into one or operated in the combined state, the present disclosure is not limited to such an embodiment. That is, all the elements may be selectively combined with each other without departing the scope of the invention. Furthermore, when it is described that one comprises (or includes or has) some elements, it should be understood that it may comprise (or include or has) only those elements, or it may comprise (or include or have) other elements as well as those elements if there is no specific limitation. Unless otherwise specifically defined herein, all terms including technical or scientific terms are to be given meanings understood by those skilled in the art. Like terms defined in dictionaries, generally used terms needs to be construed as meaning used in technical contexts and are not construed as ideal or excessively formal meanings unless otherwise clearly defined herein.

Although embodiments have been described with reference to a number of illustrative embodiments thereof, it will be understood by those skilled in the art that various changes in form and details may be made therein without departing from the spirit and scope of the invention as defined by the appended claims. Therefore, the preferred embodiments should be considered in descriptive sense only and not for purposes of limitation, and also the technical scope of the invention is not limited to the embodiments. Furthermore, the invention is defined not by the detailed description of the invention but by the appended claims, and all differences within the scope will be construed as being comprised in the present disclosure.

What is claimed is:

1. A financial device comprising:
a transferring device comprising a first guider and a second guider, which are spaced apart from each other to form a transfer path of a medium, and a frame on which the first and second guiders are installed; and
a light emitting sensor and a light receiving sensor, which sense the medium transferred along the transfer path of the medium,
wherein the light emitting sensor and the light receiving sensor do not overlap the transfer path of the medium in a direction vertical from the transfer path of the medium.

2. The financial device of claim 1, further comprising:
a wire transmitting an electrical signal; and
a control part connected to the light emitting sensor and the light receiving sensor through the wire,
wherein the wire do not overlap the transfer path of the medium in the direction vertical from the transfer path the medium.

3. The financial device of claim 1, further comprising:
a first path part through which light emitted from the light emitting sensor passes; and
a second path part guiding the light from the first path part to the light receiving sensor,
wherein the medium passes between the first path part and the second path part.

4. The financial device of claim 3, wherein the first path part and the second path part pass through the frame.

5. The financial device of claim 3, wherein the first path part comprises a first optical cable through which light passes, and
the second path part comprises a second optical cable through which light pass.

6. The financial device of claim 5, wherein the first path part comprises a first light guider connected to the light emitting sensor and the first optical cable to converge light on the first optical cable, and a second light guider connected to the first optical cable to spread the light emitted from the first optical cable, and
the second path part comprises a fourth light guider for converging the light emitted from the second light guider, on the second optical cable, and a third light guider connected to the light emitting sensor to spread the light emitted from the second optical cable to the light receiving sensor.

7. The financial device of claim 1, further comprising:
a first path part through which light emitted from the light emitting sensor passes; and
a second path part guiding the light passing through the first path part, to the light receiving sensor,
wherein the first and second path parts are disposed above or under the transfer path of the medium.

8. The financial device of claim 7, wherein the first path part and the second path part comprise a prism.

9. The financial device of claim 1, wherein the frame comprises:
a first frame connected to a side of the first and second guiders; and
a second frame connected to the other side of the first and second guiders,
wherein the light emitting sensor and the light receiving sensor are disposed at a side of one of the first frame and the second frame.

10. The financial device of claim 1, wherein the frame comprises:
a first frame connected to a side of the first and second guiders; and
a second frame connected to the other side of the first and second guiders,
wherein the light emitting sensor is disposed at a side of one of the first and second frames, and
the light receiving sensor is disposed at a side of the other of the first and second frames.

11. A financial device comprising:
a transferring device comprising a first guider and a second guider, which are spaced apart from each other to form a transfer path of a medium, and a frame on which the first and second guiders are installed;
a light emitting sensor for emitting light to sense the medium transferred along the transfer path of the medium;
a light receiving sensor for receiving the light from the light emitting sensor;
a control part electrically connected to the light emitting sensor and the light receiving sensor;
a first wire connecting the light emitting sensor to the control part; and
a second wire connecting the light receiving sensor to the control part,
wherein the first wire and the second wire do not overlap the transfer path of the medium in a direction vertical from the transfer path of the medium.

12. The financial device of claim 11, wherein the light emitting sensor and the light receiving sensor are disposed at a side of the frame, and
the frame comprises a hole through which light passes.

13. The financial device of claim 11, further comprising:
a first path part through which light emitted from the light emitting sensor passes; and
a second path part guiding the light from the first path part to the light receiving sensor,
wherein the first path part and the second path part overlap the transfer path of the medium in the direction vertical from the transfer path of the medium.

14. The financial device of claim 13, wherein the first path part comprises a first optical cable through which light passes, and
the second path part comprises a second optical cable through which light pass.

15. The financial device of claim 14, wherein the first path part comprises a first light guider connected to the light emitting sensor and the first optical cable to converge light on the first optical cable, and a second light guider connected to the first optical cable to spread the light emitted from the first optical cable, and
the second path part comprises a fourth light guider for converging the light emitted from the second light guider, on the second optical cable, and a third light guider connected to the light emitting sensor to spread the light emitted from the second optical cable to the light receiving sensor.

16. The financial device of claim 13, wherein the first path part and the second path part comprise a prism for refracting light.

17. The financial device of claim 13, wherein one of the first and second path parts comprises an optical cable through which light passes, and
the other of the first and second path parts comprises a prism for refracting light.

18. A sensing apparatus comprising:
a light emitting sensor for emitting light; and
a light receiving sensor sensing the light emitted from the light emitting sensor to generate an electrical signal,
wherein the light emitting sensor and the light receiving sensor do not overlap a plane of a sensing region for sensing the presence of an object, in a direction vertical from the plane of the sensing region.

19. The sensing apparatus of claim 18, further comprising:
a wire for transmitting an electrical signal; and
a control part connected to the light emitting sensor and the light receiving sensor through the wire,
wherein the wire does not overlap the plane of the sensing region in the direction vertical from the plane of the sensing region.

20. The sensing apparatus of claim 18, further comprising a first path part for guiding light emitted from the light emitting sensor, to the sensing region; and
a second path part for guiding the light from the first path part to the light receiving sensor,
wherein the first and second path parts overlap the plane of the sensing region in the direction vertical from the plane of the sensing region.
